(19) United States
(12) Patent Application Publication
(10) Pub. No.: US 2005/0034798 A1
(43) Pub. Date: Feb. 17, 2005

(54) Tread and method for use

(76) Inventor: Donald Anthony Bright, Cleveland, TN (US)

Correspondence Address: MICHELINE KELLY JOHNSON;BAKER, DONELSON, BEARMAN, CALDWELL & BERKOWITZ, PC, 1800 REPUBLIC CENTRE, 633 CHESTNUT STREET, CHATTANOOGA, TN, 37450-1800, US

(21) Appl. No.: 10/916,708

(22) Filed: Aug. 12, 2004

Related U.S. Application Data
(60) Provisional application No. 60/495,452, filed on Aug. 14, 2003.

(51) Int. Cl. B60C 11/117; B60C 11/02; B60C 19/00; B29D 30/54; B62D 55/26

(52) U.S. Cl. 152/209.17; 152/209.6; 305/157; 305/185; 156/96; 156/94

(57) ABSTRACT

An improved tread having a grid-like pattern formed of self-supporting, connecting protuberances, such that a chamber is disposed between the protuberances. The chamber of the improved tread is capable of dispersing at least one of fluids, solids, and fluid-solid mixtures.

### 35 USC § 119(E) CLAIM TO A PROVISIONAL U.S. APPLICATION

This application claims the benefit of U.S. Provisional Application No. 60/495,452, filed Aug. 14, 2003.

### BACKGROUND OF THE INVENTION

1. Field of Invention

The present invention relates to a tread design, and more specifically, to a tread design for use in a low speed/high traction tire, retread, or track with off-road applications.

2. Description of the Background Art

In order to obtain traction in environments of mud, snow, or sand, tire manufacturers have provided knobbies, beefy lugs, and extensions or protuberances extending from an exterior surface of the tire tread. These projections were utilized to assist in providing traction in applications of mud, snow, sand, etc., and extended from the exterior at a base to a tip. The Applicant is unaware of any cross sectional areas of tips greater than cross sectional areas of bases. Furthermore, the tips were not connected to each other.

In operation, the grooves that are formed intermediate the projections typically become filled with viscous fluid and/or solid materials that do not readily eject from the surface of the tire. Once fluid and material becomes packed up to the level above the periphery of the extensions from the tire, the traction capabilities of the projections are severely, if not completely, reduced or eliminated in terms of effectiveness, thereby causing the wheel to lose traction.

Similarly, track products for use on armored vehicles or other off-road vehicles or equipment have featured rubber and metallic surfaces with flat contact portions and linkages along the endless track. While the linkages provide for some self-cleaning of the endless track, the flat contact portions or traveling pads offer little additional traction to the endless track. Moreover, the overall design is expensive to manufacture due to the assembly required of separate rubber and/or metal parts to make an endless track.

Accordingly, there exists a need for a method and a tread apparatus that maintains traction more efficiently than the prior art tires, tire retreads, and tracks, especially in low-speed off-road applications. A further need in the art exists for a method and tread with an improved self-cleaning function. Another need in the art exists for a method and tread for increasing traction of a wheel or endless track of a vehicle that provides for self-cleaning chambers to maximize traction of a vehicle wheel or track while also providing for great stability of the vehicle. A need in the art also exists for a method and tread for increasing traction of a wheel or tread on a vehicle that treads lightly on surfaces. An additional need in the art exists for a method and tread for increasing traction of a wheel or track of a vehicle that is relatively inexpensive to manufacture.

### SUMMARY OF THE INVENTION

Accordingly, it is the primary object of the present invention to provide a tread apparatus that includes a chamber which is capable of disbursing at least one of fluids, solids, and fluid-solid mixtures present in terrain adjacent to a vehicle.

It is another object of the present invention to provide a traction device that is self-cleaning when a vehicle tire or track traverses or penetrates through at least one of fluids, solids, and fluid-solid mixtures.

It is the further object of the present invention to provide a method and tread apparatus for increasing traction of a wheel or a track of a vehicle that is durable yet treads lightly on surfaces traversed by a vehicle.

Another object of the present invention is to provide both a method and tread apparatus for increasing traction of a wheel or a track of a vehicle that is readily and economically manufactured.

It is the further object of the present invention to provide a traction device that generates greater vehicle stability and tremendous gripping force.

These and other objects of the present invention are fulfilled by providing a traction device comprising a grid formed by the interconnection of protuberances, integrally related and self-supporting, that forms a tread which may serve as an exterior surface of a tire or track. The tread has inverted and stepped ledge walls extending inwardly from the exterior surface, or periphery, into the tread face to provide a plurality of chambers. Instead of extending outwardly from the tread face as is known to have been done in the prior art, the provision of chambers with inwardly stepped ledge walls is envisioned. As the tire or tread rotates, an applied load on the tire causes the chambers to compress and then release quickly as the weight is diminished (i.e., as the tire rotates past the point of compression on any particular chamber). Additionally, inherent centrifugal forces are experienced by the rotation of the tire, which also assist in the removal of any material deposited with the chambers. Furthermore, material characteristics of the chambers such as being constructed of a material having Teflon™ type characteristics assist in the removal of deposited material. Anti-sticking rubber compounds have been found to assist in providing this self-cleaning capability.

While the chambers are preferably diamond in shape, they could otherwise be square, rectangular, circular, or other geometrical shape with tapered inverted walls.

Additionally, these and other objects of the present invention are fulfilled by a method for increasing the traction of a wheel or track of a vehicle, the method of comprising the steps of operatively linking a plurality of tread grids together; attaching the plurality of tread grids to the wheel or track of the vehicle; and disbursing at least one of fluids, solids, and fluid-solid mixtures adjacent to the wheel of the vehicle with chambers disposed in the tread grids.

Further scope of applicability of the present invention will become apparent from the detailed description given hereinafter. However, it should be understood that the detailed description and specific examples, while indicating preferred embodiments of the invention, are given by way of example and illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side plan view of a tire constructed in accordance with the present invention;

FIG. 2 is a front plan view of the tire illustrated in FIG. 1;

FIG. 3 is a detailed plan view of the area illustrated as Section A in FIG. 2;

FIG. 4 is a cross section taken along the line B-B in FIG. 3; and

FIG. 5 is a detailed side perspective view of the area illustrated as Section C in FIG. 2.

### DETAILED DESCRIPTION OF THE PREFERRED EMBODIMENTS

Referring in detail to the drawings and with particular reference to FIGS. 1 and 2, the tire 10 equipped with the tread 12 of the first embodiment of the present invention is illustrated. Instead of extending from an exterior surface portion of a tire as has been done in the prior art, the tread 12 is equipped with an exterior surface 14 which extends around about the periphery or circumference of the tire 10. Internal to the exterior surface 14 are chambers 16 which are formed into the exterior surface 14. More detail about the chambers 16 can be seen in the detailed views of FIGS. 3-5.

The chambers are capable of dispersing at least one of fluids, solids, and fluid-solid mixtures which lay adjacent to a wheel of a vehicle. The chambers are designed to equally disperse fluids, solids, and fluid-solid mixtures in order to provide a mechanical gripping advantage for a wheel of a motor vehicle. The chambers 16 become pressurized during use by the surface of a wheel of a motor vehicle and the terrain disposed beneath the wheel of a motor vehicle. The pressurization of the chambers 16 provides for a self-cleaning design where fluids, solids and fluid-solid mixtures are released outside of a load zone on the tire 10.

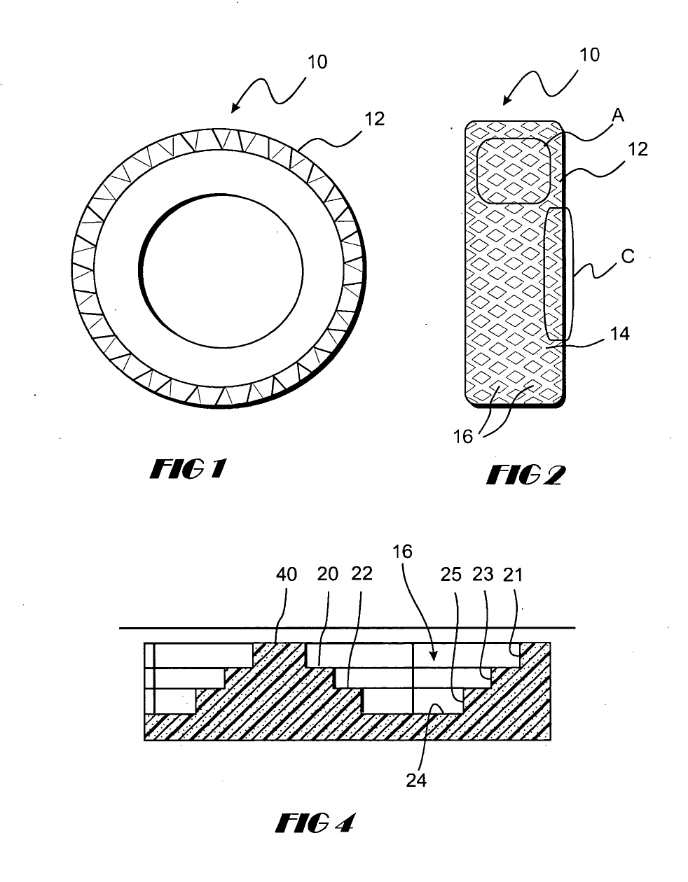

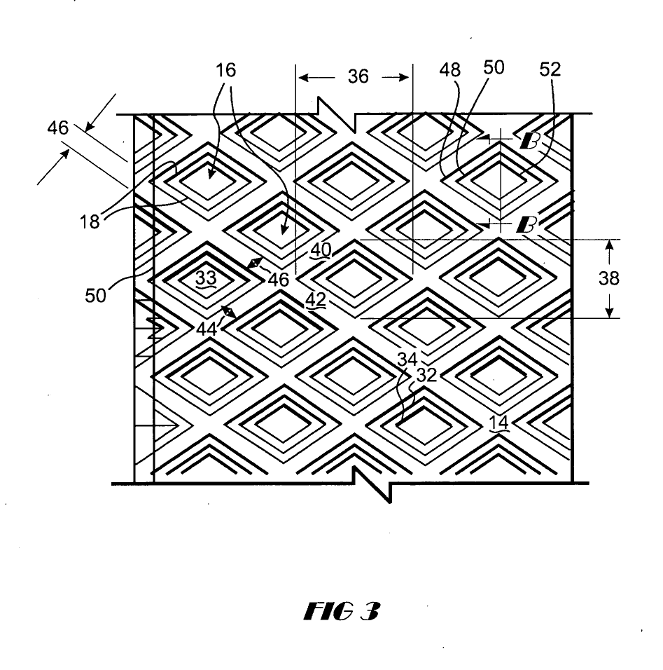

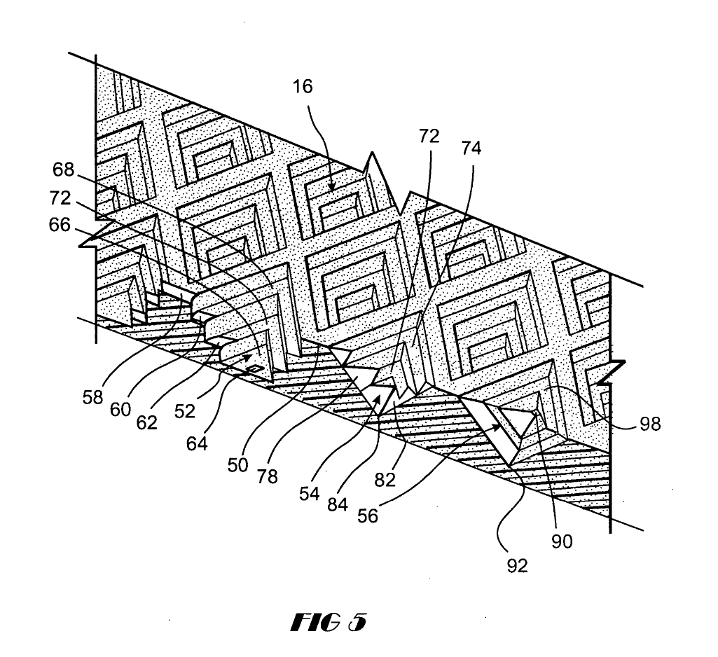

As shown in FIGS. 3-5, the chambers 16 are preferably comprised of connected inverted tapered ledge walls 18. The walls 18 in addition to being tapered are also stepped, as can be more clearly seen in FIGS. 4 and 5 through the cross sectional and perspective nature of the views. By “stepped” is meant that relative to the exterior surface 14, first step 20 is located a first distance spaced apart from the exterior surface 14 by shoulder 21. Second step 22 is located a second predetermined distance from the exterior surface 14 and a third predetermined distance from the first step 20 by shoulder 23. The third step 24 is located a fourth predetermined distance from the exterior surface 14 and a fifth predetermined distance from the second step 22 by shoulder 25. The fourth predetermined distance is greater than the second predetermined distance, which is greater than the first predetermined distance. The first, third, and fifth predetermined distances are illustrated as being equal in the preferred embodiment. This may not be the case in other embodiments.

The steps 20, 22, and 24 are disposed radially inward of the exterior surface 14 of the tire tread 12 about tire 10. In the preferred embodiment, the walls 18 are both stepped, as illustrated, as well as narrowing, or inverted, such that a perimeter of the exterior surface 26 of the first step 20 is greater than a perimeter of the exterior surface 24 of the second step 22, which is greater than a perimeter of the exterior surface 30 of the third step 24. In fact, in the preferred embodiment, the interior perimeter 32 of the first step 20 corresponds with the exterior perimeter 28 of the second step 22, and the interior perimeter 34 of the second step 22 corresponds with the exterior perimeter 30 of the third step 24.

The steps 20, 22, and 24 form a plurality of sub-chambers within chambers 16, by virtue of the intersection at pre-determined angles of the substantially linear portions of steps 20, 22, and 24 disposed on walls 18. The sub-chambers are substantially diamond-shaped where the intersection of the substantially linear step projections 20, 22, and 24 form chevrons. The sub-chambers and the relative location on the tread 12 enhance the frictional contact of the tread 12 on a terrain disposed beneath the wheel of a vehicle. The sub-chambers enhance the friction of the tread 12 and provide for a rapid release of fluids, solids, and fluid-solid mixtures that lay adjacent to a wheel of a vehicle. The sub-chambers increase the friction (or co-efficient of friction—static and kinetic) of the tread 12 during both forward and reverse rotations of a wheel or track of a vehicle.

The inverted steps 20, 22, and 24 reduce the surface adhesion of fluids, solids, and fluid/solid mixtures that fill the chambers 16 and thus provide for quick release or rapid adjustment of the fluids, solids, and fluid/solid mixtures as the tire rotates away from a terrain.

Tread 12 is preferably made from an elastomeric compound with a pre-determined molecular weight. However, other materials are not beyond the scope of the present invention. Other materials include, but are not limited to, other polymers such as thermoplastic polymers, composite materials, and other like materials. The material for the tread 12 is selected according to the following parameters: the material for the tread 12 should increase the friction of a wheel or track of a vehicle while not substantially marring or degrading the terrain on which the wheel or track of the vehicle travels; and the material of the tread 12 should be durable for increased product life.

As noted above, the operational environment contemplated for the present invention is for terrain which includes fluids, solids and/or fluid-solid mixtures. Such environments would include, but would not be limited to, mud, snow, sand, ice, rain, water, rock, rough terrain with foliage like trees and grass, and other obstacles associated with terrain of a vehicle.

The present invention provides for a method of increasing traction of a wheel or track of a vehicle. The method of the present invention includes operatively linking a plurality of tread 12 portions together and attaching the resultant repetitive grid pattern to the outer surface of a tire, a tire retread, or an endless loop track. In the preferred embodiment of the present invention, the tread 12 is disposed continuously across the outer surface of the outer terrain-contacting surface of either a tire, a tire retread, or a track.

The method for increasing traction of a wheel or tread of a vehicle further includes the steps of disbursing at least one of fluids, solids, and fluid-solids mixtures adjacent to the wheel or track of a vehicle with chambers 16 disposed in each tread 12.

The present invention provides both a method and apparatus for increasing traction of a wheel or track of a vehicle when a vehicle tire or track traverses or penetrates through at least one of fluids, solids, and fluid-solid mixtures. The invention provides for greater stability of a vehicle while simultaneously providing increased traction and substantially reducing damage to the terrain traversed. The invention includes an integrally woven and self-supporting grid system of interconnecting protuberances that form chambers capable of disbursing at least one of fluids, solids, and fluid-solid mixtures present in a terrain adjacent to a motor vehicle.

Referring now to FIG. 3, the footprint of the chamber 16 preferably has a width 36 which is greater than the length 38. In fact, the ratio of the width 36 to length 38 is illustrated as about 3/2 in the preferred embodiment. The footprint corresponds with the exterior perimeter surface 26 of the first step 20 in the preferred embodiment. Since the second and third steps are preferably concentrically oriented relative to the first step 20, the width to length dimensions of the second and third steps are also preferably about 3/2. However, other ratios are conceivable, as is a non-concentric arrangement.

The cells or chambers 16 are preferably arranged in a repeating pattern as shown in FIG. 3. The ridges 40, 42 are intermediate adjacent chambers 16 and are illustrated forming a grid pattern. When the chambers 16 are formed in a parallelogram fashion, this is the case. However, in other embodiments the chambers 16 may be constructed in other geometric shapes which could affect the shape of the ridges 40, 42.

As shown in FIG. 3, the ridges 40, 42 preferably have widths 44, 46 which are approximately twice the width of either of the first and second steps 20, 22. By providing a relatively narrow ridge 40, 42 in a relatively compressible material, advantages of the preferred embodiment may be easily understood. Instead of having extending members such as spaced apart protuberances, extensions, beefy lugs, or knobbies, the chambers 16 provide the inverse of the prior art structural concepts. Specifically, the chambers are inwardly tapered and are preferably provided with several steps 20, 22, 24.

The inverted steps 20, 22, 24 reduce the surface adhesion of fluids, solids, and fluid-solid mixtures that fill the primary and secondary chambers 16 and thus, provide for quick release or rapid ejectment of the fluids, solids, and fluid-solid mixtures as the tread 12 rotates away from a terrain. Thus, the chambers 16 are capable of disbursing at least one of fluids, solids, and fluid-solid mixtures that lay adjacent to a wheel or track of a motor vehicle. Chambers 16 are designed to equally disburse fluids, solids, and fluid-solid mixtures in order to provide a mechanical gripping advantage for a wheel or track of a motor vehicle. The chambers 16 become pressurized during use by the surface of a wheel or track of a motor vehicle and the terrain disposed beneath the wheel or track of a motor vehicle. The pressurization of the chamber 16 provides for a self-cleaning design where fluids, solids, and fluid-solid mixtures are released outside of a load zone on the tread 12.

The sides and mass of the chambers 16 and walls 18 also correspond to the depth and area of the steps 20, 22, 24 and dictate the performance specifications of the particular tread 12. It is believed to be important to know the anticipated load and rim speeds of the tire 10. Off-road service is the preferred application of the tire 10. By “off-road,” it is meant that the tire 10 is intended for use with lawn mowers, tractors, mountain bikes, ATVs, earthmoving equipment, dune buggies, motorcycles, jeeps, and many other non-road uses such as flotation, swamp tires, use on a ski slope, powerline, and rice paddy services, etc. There are very few limitations known to the use of the tire 10 of the preferred embodiment. When applied to prefabricated retread manufacture, the tread 12 can be utilized with recycled tires for such vehicles. Similarly, tread can be manufactured into an endless loop for additional types of off-road vehicles and equipment, both military and civilian. In this embodiment, the tread 12 may be provided with an internal roller guide system on its reverse or under side. Guide lugs can be formed by extrusion to support the track rollers and prevent the tread 12 from pulling off to the side of a track.

The inverted stepped walls 18 are believed to create tremendous adhesion (grip) to solid surfaces beneath slippery material such as mud, snow, and/or sand. The chambers 16 are preferably diamond shaped and include diamond shaped steps 20, 22, 24. The edges 48, 50, 52 assist in defining chevrons both with respect to the steps 20, 22, 24 as well as with respect to the shoulders 21, 23, 25 intermediate the edges 48, 50, 52. The chambers 16 also support the resistance and opposing forces in virtually all directions, especially forward and reverse, as well as side to side directions. Thus, the grid design of tread 12 functions to better support the load of a vehicle than would a tread of the prior art. Knobbies tend to deflect, rather than support, a load, especially when it is placed axially thereto. Furthermore, the grip retained in forward or reverse directions is believed to assist in preventing axial movement (side skidding) with quadrilateral support provided by the perimeter edges 48, 50, 52 of the diamond shaped chambers 16.

When encountering granular fluid solids, the fluid is directed by the ridges 40, 42 into the chambers 16. Chamber 16 supports the weight of the vehicle on the material or granular fluid solids deposited therein instead of marring up or negatively affecting the traction capability of the tread 12. In this manner the tread 12 functions as camel feet to prevent sinking or digging into the muck or ice. This feature is also believed to at least significantly reduce, if not eliminate, additional problems such as spinning out of control. By having the inverted and stepped construction of the chambers, the amount of material deposited closest to the axis of rotation (i.e., deepest into the tire tread) is significantly less than the mass of the material located at the periphery of the chamber 16 or at the same radial distance as the exterior surface 14 of the tread 12. Accordingly, the centrifugal force of the tire as it is rotated is believed to cause the entrapped material to be ejected due to the rotational force in conjunction with the anti-sticking nature of the material constructing the tread 12.

Preferably, the material is constructed of a closed cell rubber that provides anti-sticking tendencies. Accordingly, upon tire rotation, foreign materials within the chamber 16 are ejected. Furthermore, since the tread 12 increases the square inch contact area with less mass, there is significantly reduced detriment to the environment and the eco-system as the tread profile “treads lightly” as it traverses about a terrain.

The material of the tread 12 is preferably selected so that the ridges 40, 42 as well as at least some of the steps 20, 22, 24 and/or shoulders 21, 23, 25 compress under load, at least partially. Accordingly, if no material is deposited within a particular chamber 16, then a significant portion of the steps 20, 22, 24 and/or shoulders 21, 23, 25 also are believed to contact the terrain as the tread 12 is rotated. These radially inwardly directed surfaces are brought towards a contact surface with the terrain as the ridges 40, 42, steps 20, 22, 24 and/or shoulders 21, 23, 25 are compressed by the applied load. Once the applied load is removed by the action of the tire rotating past a given chamber 16, the applied load is relatively quickly released, thereby assisting in dislodging any material entrapped therein, especially when coupled with a centrifugal force and the anti-sticking properties as described above.

When the tread 12 encounters smooth and slippery surfaces such as wet and muddy conditions or ice-covered terrain, the chambers 16 become a series of suction cups. Specifically, the weight of applied load on the tires 10 serves to compress the chamber walls 18, thereby tending to form a vacuum in the chamber 16. Accordingly, as load diminishes with the rotation, the chambers 16 are found to provide more adhesion at lower speeds than are normally associated with off-road tires.

Should the tread 12 encounter steep grade, rocks, and/or tree limbs or other structures frequently encountered in off-road applications, the chamber construction is advantageous as well. Specifically, the walls 18 of the chamber 16 have been found to deflect to the contour of the obstacles and grip the terrain surface since the material which the ridges 40, 42, steps 20, 22, 24, and/or shoulders are constructed of is preferably compressible under the load, at least partially. Accordingly, chamber 16 deflects to the contour of the terrain obstacles so that the ridges 40, 42, steps 20, 22, 24 and/or shoulders 21, 23, 25 grip and conform to the terrain surfaces unlike the prior art. In the prior art, various shaped lugs or knobbies do not tend to bite into hard surfaces, and can often prevent further travel when hard surfaces are encountered.

In the preferred embodiment, the diamond shaped chambers 16 form cavities within the periphery of the tire profile. These chambers 16 provide an opposite image compared with traditional knobby tires. What used to be a positive becomes a negative, and what used to be grooves in tires become tapered and stepped ledges and ridges. These tapered and stepped ledges and ridges extend inwardly relative to the inwardmost step illustrated as third step 24 so that the steps 20, 22 as well as ridges 40, 42 replace the lugs and knobbies and provide much more surface area and traction. This major difference in the prior art becomes obvious when observing tracks of the tread 12 upon left in a terrain. The footprint of the tread profile on a terrain surface has the appearance of a unique tire tread.

The preferred material utilized for the tread 12 is an anti-sticking urethane rubber which has been found to exceed the performance requirements of the tread 12. The chamber 16 has stepped-wedge walls 16, 18 that invert (taper inwardly). The chambers provide for foreign material such as fluids and solids to be deposited within the chamber 16 and as the pressure of the applied load is applied to the chamber, the chamber 16 creates a gripping effect upon the contacting surface. As load diminishes, centrifugal forces of tire rotation are applied, thereby causing the fluid and solid mass to be relatively easily ejected away from the chambers 16. This results in a self-cleaning tread pattern. Once at least partially emptied, the chambers 16 are then ready for the next revolution to repeat this cycle and provide continuous gripping capability and improved efficiency as it relates to traction.

Although the diamond perimeter shapes of the chamber 16 are the presently preferred embodiment, alternative embodiments may provide for square, rectangular, other parallelogram, or even other geometric shapes including rounded shapes. Additionally, although several steps are shown, either a single step having an inwardly tapered wall or simply an inwardly tapered chamber with no step may be utilized in place of a plurality of steps as is illustrated in the preferred embodiment.

As shown in FIGS. 3 and 5, at the tire edges 50, the edge chambers 52, 54, 56 are constructed slightly differently than the chambers 16 internal to the tire edges 50. In fact, three different embodiments of edge chamber embodiments are illustrated as first, second and third edge chambers 52, 54, 56. The first edge chamber 52 is a straight-forward run-off design that has round edges 58, 60, 62. Furthermore, in this first edge chamber 52 design, the chamber 52 extends to an edge 64 along bottom step 66 at top step 68 and little steps 70. The edges 72, 74 parallel the side-most edge 64 of bottom step 66. Accordingly, as the chamber 52 is compressed, any material in the chamber 52 would be preferentially directed out past the outermost edge 64 from the chamber 52. This is the presently preferred edge chamber 52.

The second edge chamber 54 is illustrated having similar intermediate and upper steps 72, 74 but the bottom step 76 is a point. This is known as a simplified taper, as the walls 78, 80 are symmetrical about edge 82 and extend to a point 84, which is believed to assist in directing fluid and/or solid material out of the chamber 54 past the point 84 as the tire 10 is rotated and/or the second edge chamber 54 is compressed.

Finally, in the third edge chamber 56, a first step 86 extends to the tire edge 50 where it is then symmetrically relative to divider 88. A second step 90 is located internal to the first step 86 and may also be similarly constructed relative to divider 88 and out past the point 92 as the chamber 56 is compressed.

Although the tread 12 of the present invention has thus been described in connection with its use as the integral exterior circumference of a tire, it is to be understood that the tread 12 can also be formed as a prefabricated tire retread, to be adhered to a recycled tire. Alternatively, the tread 12 may be formed into an endless loop for use on tracked vehicles. Moreover, the tread 12 of the present invention could also serve effectively as a sole for footwear.

The invention being thus described, it will be obvious that the same may be varied in many ways. Such variations are not to be regarded as a departure from the spirit and scope of the invention, and all such modifications as would be obvious to one skilled in the art were intended to be included within the scope of the following claims.

1. A tread comprising:
a grid having a concave chamber, said chamber being capable of dispersing at least one of fluids, solids, and fluid-solid mixtures away from said tread.

2. The tread of claim 1, wherein said chamber has a predetermined number of sides being disposed therein.

3. The tread of claim 1, wherein said chamber has a substantially circular shape.

4. The tread of claim 1, wherein said chamber has a substantially elliptical shape.

5. The tread of claim 1, wherein said chamber has a substantially diamond shape.

6. The tread of claim 1, wherein said grid is made of at least one of plastic and rubber.

7. The tread of claim 1, wherein said chamber is a primary chamber, the tread further comprising a plurality of secondary chambers being disposed adjacent to said primary chamber, said primary and secondary chambers being capable of dispersing at least one of fluids, solids, and fluid-solid mixtures.

8. The tread of claim 1, wherein said chamber is defined by wall members, each wall member having a plurality of subchambers disposed on a surface thereof.

9. A tire having a tread comprising a grid having a concave chamber, said chamber being capable of dispersing at least one of fluids, solids, and fluid-solid mixtures away from said tread.

10. The tire of claim 9, wherein said chamber has a predetermined number of sides being disposed therein.

11. The tire of claim 9, wherein said chamber has a substantially circular shape.

12. The tire of claim 9, wherein said chamber has a substantially elliptical shape.

13. The tire of claim 9, wherein said chamber has a substantially diamond shape.

14. The tire of claim 9, wherein said grid is made of at least one of plastic and rubber.

15. The tire of claim 9, wherein said chamber is a primary chamber, the tread further comprising a plurality of secondary chambers being disposed adjacent to said primary chamber, said primary and secondary chambers being capable of dispersing at least one of fluids, solids, and fluid-solid mixtures.

16. The tire of claim 9, wherein said chamber is defined by wall members, each wall member having a plurality of subchambers disposed on a surface thereof.

17. The tire of claim 9, wherein said tread has decreasing thickness at the edges of the terrain-contacting surface of the tire.

18. A tire retread having a tread comprising a grid having a concave chamber, said chamber being capable of dispersing at least one of fluids, solids, and fluid-solid mixtures away from said tread.

19. The tire retread of claim 18, wherein said chamber has a predetermined number of sides being disposed therein.

20. The tire retread of claim 18, wherein said chamber has a substantially circular shape.

21. The tire retread of claim 18, wherein said chamber has a substantially elliptical shape.

22. The tire retread of claim 18, wherein said chamber has a substantially diamond shape.

23. The tire retread of claim 18, wherein said grid is made of at least one of plastic and rubber.

24. The tire retread of claim 18, wherein said chamber is a primary chamber, the tread further comprising a plurality of secondary chambers being disposed adjacent to said primary chamber, said primary and secondary chambers being capable of dispersing at least one of fluids, solids, and fluid-solid mixtures.

25. The tire retread of claim 18, wherein said chamber is defined by wall members, each wall member having a plurality of subchambers disposed on a surface thereof.

26. The tire retread of claim 18, wherein said tread has decreasing thickness at the edges of the terrain-contacting surface of the tire.

27. An endless track having a tread comprising a grid having a concave chamber, said chamber being capable of dispersing at least one of fluids, solids, and fluid-solid mixtures away from said tread.

28. The endless track of claim 27, wherein said chamber has a predetermined number of sides being disposed therein.

29. The endless track of claim 27, wherein said chamber has a substantially circular shape.

30. The endless track of claim 27, wherein said chamber has a substantially elliptical shape.

31. The endless track of claim 27, wherein said chamber has a substantially diamond shape.

32. The endless track of claim 27, wherein said grid is made of at least one of plastic and rubber.

33. The endless track of claim 27, wherein said chamber is a primary chamber, the tread further comprising a plurality of secondary chambers being disposed adjacent to said primary chamber, said primary and secondary chambers being capable of dispersing at least one of fluids, solids, and fluid-solid mixtures.

34. The endless track of claim 27, wherein said chamber is defined by wall members, each wall member having a plurality of subchambers disposed on a surface thereof.

35. The endless track of claim 27, wherein said tread has decreasing thickness at the edges of the terrain-contacting surface of the tire.

36. Footwear having a tread comprising a grid having a concave chamber, said chamber being capable of dispersing at least one of fluids, solids, and fluid-solid mixtures away from said tread.

37. The footwear of claim 36, wherein said chamber has a predetermined number of sides being disposed therein.

38. The footwear of claim 36, wherein said chamber has a substantially circular shape.

39. The footwear of claim 36, wherein said chamber has a substantially elliptical shape.

40. The footwear of claim 36, wherein said chamber has a substantially diamond shape.

41. The footwear of claim 36, wherein said chamber is a primary chamber, the tread further comprising a plurality of secondary chambers being disposed adjacent to said primary chamber, said primary and secondary chambers being capable of dispersing at least one of fluids, solids, and fluid-solid mixtures.

42. The footwear of claim 36, wherein said chamber is defined by wall members, each wall member having a plurality of subchambers disposed on a surface thereof.

43. The footwear of claim 36, wherein said grid is made of at least one of plastic and rubber.

44. The footwear of claim 36, wherein said tread has decreasing thickness at the edges of the terrain-contacting surface of the tire.

45. A method for increasing the traction of a wheel of a vehicle, the method comprising the steps of:
operatively linking a plurality of tread grids together;
affixing the tread grids to a wheel of a vehicle while the wheel of the vehicle is in a stationary position; and
dispersing at least one of fluids, solids, and fluid-solid mixtures adjacent to the wheel of the vehicle with chambers disposed in said tread grids when said wheel is in motion.

46. A method for increasing the traction of a track of a vehicle, the method comprising the steps of:
operatively linking a plurality of tread grids together;
affixing the tread grids to a track of a vehicle while the track of the vehicle is in a stationary position; and
dispersing at least one of fluids, solids, and fluid-solid mixtures adjacent to the track of the vehicle with chambers disposed in said tread grids when said track is in motion.
